(19) United States
(12) Patent Application Publication
(10) Pub. No.: US 2008/0206707 A1
(43) Pub. Date: Aug. 28, 2008

(54) ORAL APPLIANCE FOR IMPROVING AIRWAY FUNCTION DURING SLEEP OR PHYSICAL ACTIVITY

(76) Inventor: Michael Gelb, Hartsdale, NY (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/023,680

(22) Filed: Jan. 31, 2008

Related U.S. Application Data
(60) Provisional application No. 60/898,794, filed on Jan. 31, 2007.

(51) Int. Cl. A61C 5/14; A61C 5/00

(52) U.S. Cl. 433/140; 128/859; 128/861

(57) ABSTRACT

Oral appliances which reside within the mouth and which bring the lower jaw and/or the tongue forward to increase airway flow during sleep or physical activity are provided. Furthermore, the oral appliances are constructed such that they may be optionally customized to an individual user's mouth shape. Methods of using such oral appliances are also provided.

### RELATED APPLICATIONS

This application claims benefit of U.S. provisional patent application No. 60/898,794, filed Jan. 31, 2007, the contents of which are incorporated herein by reference.

### FIELD OF THE INVENTION

The present invention is directed to an oral appliance which increases airway flow during sleep or physical activity. More particularly, the present invention includes an oral appliance which resides within the mouth and which brings the lower jaw forward to increase airway flow during sleep or physical activity. Furthermore, the oral appliance optionally includes a bulb to bring the tongue into a forward position, thus further increasing airway flow. The oral appliance is constructed such that it may be customized to an individual user's mouth shape.

### BACKGROUND INFORMATION

During sleep, the lower jaws of many people fall back into the mouth due to gravity. Additionally, the tongue muscle often relaxes and falls back into the mouth and throat. These aforementioned locations of the lower jaw and tongue reduce the size of the airway opening by causing partial blockage of the airway during sleep. A result of this action is that many people can, and often experience, sleep apnea (e.g., the total blockage of the airway during sleep causing the patient to stop breathing for 10 seconds or longer) and snoring (e.g., vibration of tissues in the throat when breathing).

Sleep apnea is the most common and deadly systemic disease in industrialized nations. The severe consequences of sleep apnea and its unrecognized presence may make it one of the most serious health issues in the United States, a silent and undiagnosed killer. Its consequences can include heart attack, stroke, high blood pressure, minimized productivity, unsafe driving due to drowsiness and depression.

Furthermore, reduced airflow to the lungs results in activation of the sympathetic nervous response causing, among other things, increased heart rate, blood pressure and altered insulin response. This alteration in insulin response can be a cause of diabetes. Lastly, lack of REM sleep caused by deficient air flow to the lungs results in fatigue.

Currently, it is estimated that 44% of males and 28% of females are habitual snorers. It has been estimated that by the age of 40, 40% of all males and 20% of all females snore. By age 60, 60% of all males and 40% of all females snore.

It is also estimated that 24% of all men and 9% of all women meet the minimum criteria for a diagnosis of sleep apnea and also have daytime hypersomnolence (excessive drowsiness). One study found that roughly 8% of the population bruxes (grind their teeth) during the night, while another study demonstrated a 6.5% to 88% incidence. This seems to happen most frequently with individuals who also snore or have sleep apnea.

Still further, snoring in children and the attendant reduction in oxygen availability have been linked with attention deficit disorder. Children have historically been overlooked when it comes to snoring and sleep apnea. Recently there has been an increased emphasis and awareness of Sleep Related Breathing Disorder (commonly known as SRBD) in children. Snoring and sleep apnea are the most common sleep-related problems in children. Furthermore, when a child is sleepy, snores, and does not get a good night's sleep they may exhibit symptoms of attention deficit hyperactivity disorder (commonly referred to as ADHD).

Individuals with larger necks and smaller lower jaws are particularly prone to an adverse alignment of the jaw which can result in the aforementioned conditions. In particular, certain demographic groups, e.g., Hispanic, African American, Indian and Mediterranean peoples, who are more likely to have smaller lower jaws, are prone to the aforementioned conditions. Furthermore, overweight or obese individuals, particularly men, who tend to gain weight around their necks and have increased neck size, are also prone to the aforementioned conditions. Still further, the size of the tonsils and shape of the palate in individuals can further constrict the airway, compounding the effect of neck and jaw size.

Thus, bite plates are indicated for those suffering from sleep apnea and/or high blood pressure. In the past, oral appliances have been constructed to open the airway and to alleviate Temporomandibular joint disorders (commonly referred to as “TMD” or “TMJ”). These oral appliances include the NTI tension suppression system, the NORAD (Nocturnal Oral Airway Dilator) oral appliance and the Thermasnore oral appliance. Oral appliances, such as tongue retaining oral appliances, have also been constructed to open the airway, for example, during sleep or physical activity.

Furthermore, it has been observed that when an individual is concentrating or a particular matter or playing sports, their tongue enters into a relaxed state, falling forward. This increases the airflow to the lungs. Thus, having a relaxed advanced tongue has been observed to allow individual greater strength and allows them to enter and remain in a state of greater concentration and focus, often commonly referred to in sports as being “in the zone” or by sports psychologists as “peak performance”.

However such past oral appliances have been difficult to adjust, size and use, require the expertise of a dentist to fit, contain movable parts which require manual adjustment, lack the ability to advance the jaw and lack the combined ability to both pull the tongue forward and advance the jaw. Therefore, an effectively designed oral appliance which can be easily adjusted to various bite patterns, sized and fitted by a lay individual and which combines the benefits of a tongue retaining oral appliance and a jaw alignment oral appliance would be desirable.

### SUMMARY OF THE INVENTION

According to an exemplary embodiment of the present invention, an oral appliance grips and/or supports both the lower and upper front teeth and provides posterior tooth support, realigning or repositioning the lower jaw into an advanced position sufficient to enlarge the airway opening. The enlargement of the airway opening allows a sufficient volume of air to enter into the lungs, thus preventing or alleviating sleep apnea, increased heart rate and blood pressure, cardiovascular diseases, snoring and attention deficit disorder by increasing air flow, and thus oxygen availability, to the lungs.

According to another exemplary embodiment of the present invention, an oral appliance grips and/or supports both the lower and upper front teeth and retains the tongue, realigning and repositioning the lower jaw and tongue into an advanced position sufficient to enlarge the airway opening. The enlargement of the airway opening allows a sufficient volume of air to enter into the lungs, thus preventing or alleviating sleep apnea, increased heart rate and blood pressure, cardiovascular diseases, snoring and attention deficit disorder by increasing air flow and thus oxygen availability to the lungs.

Furthermore, because use of the aforementioned oral appliances diminishes arousals during sleep and limits sleep fragmentation, users experience increased REM (Rapid eye movement) and non-REM sleep. This increased non-REM sleep, due to use of the aforementioned oral appliances, will aid the concentration of individuals, prevent or reduce the effects of daytime fatigue, increase performance, increase energy and increase memory and learning. Still further, embodiments of the present invention can also serve to generally aid the concentration of individuals, prevent or reduce the effects of daytime fatigue, increase performance, increase energy and increase memory and learning by increasing air flow during daytime use.

### BRIEF DESCRIPTION OF THE DRAWINGS

FIG. 1 is cross-sectional view of an oral appliance situated in the mouth according to an exemplary embodiment of the present invention.

FIG. 2 is rear top perspective of an oral appliance according to an exemplary embodiment of the present invention.

FIG. 3 is a side view of an oral appliance according to an exemplary embodiment of the present invention.

FIG. 4 is a top view of an oral appliance according to an exemplary embodiment of the present invention.

FIG. 5 is a bottom view an oral appliance according to an exemplary embodiment of the present invention.

FIG. 6 is a close up of a cross-sectional view of an oral appliance showing the oral appliance situated inside the mouth and showing the location of the anterior teeth according to an exemplary embodiment of the present invention.

FIG. 6A is a close up of a cross-sectional view of an oral appliance showing the oral appliance situated inside the mouth and revealing the anterior and posterior teeth in a sagittal cut across the mouth according to an exemplary embodiment of the present invention.

FIG. 7 is cross-sectional view of an oral appliance situated in the mouth according to another exemplary embodiment of the present invention.

FIG. 8 is rear top perspective of an oral appliance according to another exemplary embodiment of the present invention.

FIG. 9 is a side view of an oral appliance according to another exemplary embodiment of the present invention.

FIG. 10 is a top view of an oral appliance according to another exemplary embodiment of the present invention.

FIG. 11 is a bottom view an oral appliance according to another exemplary embodiment of the present invention.

FIG. 12 close up of a cross-sectional view of an oral appliance showing the oral appliance situated inside the mouth according to another exemplary embodiment of the present invention.

FIG. 12A is a close up of a cross-sectional view of an oral appliance showing the oral appliance situated inside the mouth and revealing the anterior and posterior teeth in a sagittal cut across the mouth according to another exemplary embodiment of the present invention.

FIGS. 13 and 14 are schematic drawings of an athlete placing the tongue in the forward relaxed position.

FIG. 15 is a schematic drawing of an athlete placing the jaw in an advanced position.

### DETAILED DESCRIPTION OF THE INVENTION

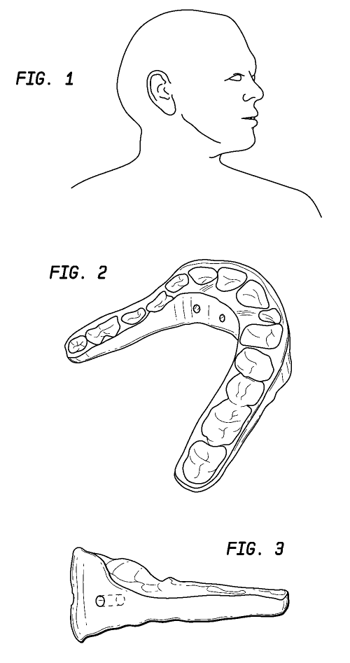

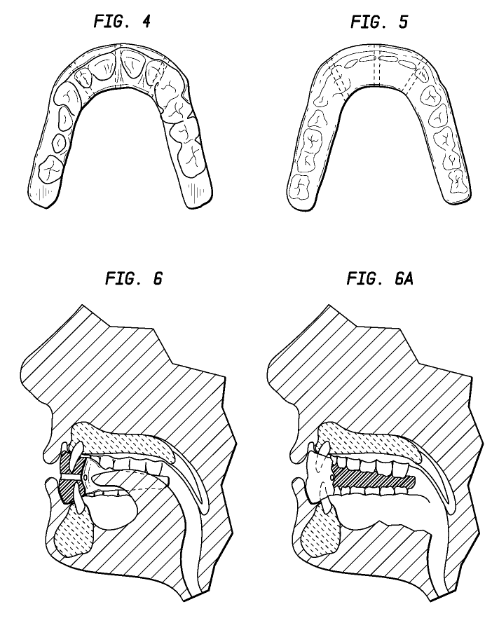

As shown in FIGS. 1-6, an oral appliance in accordance with an embodiment of the present invention comprises a single body unit 1 which has a series of grooves 2a and 2b, for the upper and lower teeth, respectively, which serve to hold the lower jaw in an advanced position. Single body unit 1 can include three passages 3a-c which allows the flow of air while the oral appliance is in use. Single body unit 1 optionally has rear extensions 4a and 4b which serve to ensure the oral appliance remains aligned within the mouth, to provide posterior support and to provide comfort to the wearer when in use. Furthermore, the groves 2a and 2b and the rear extensions 4a and 4b, or those portions of the rear extensions 4a and 4b, which contact the teeth may be composed of a filler material, as further described below.

The exterior of single body unit 1 is preferably formed from a polymer, for example an acrylic or polycarbonate. The filler material, which forms grooves 2a and 2b can be a polymer, or polymer made from for example, L-vax, Ethylene Propylene Diene Monomer (“EPDM”) or silicone which have melting temperatures from about 105° F. to about 195° F. As understood by those skilled in the art, any suitable polymer having a melting point above normal body temperature may be utilized. The single body unit 1 may be preformed in one of, for example, three sizes to accommodate different bites such as edge to edge, underbite or overbite. Alternatively, the oral appliance can be provided to users in a one size fits all mode which is accomplished by using an elastic or soft polymer which can deform to fit a variety of bites.

The grooves 2a and 2b can be formed by the user of the oral appliance by first softening single body unit 1, such as by heating in warm or hot water, and then inserting the oral appliance into the mouth and depressing the user's teeth into the softened polymer to form groove marks. The single body unit 1 is then allowed to cool, or optionally immersed in cool water to harden the single body unit 1 for use. Alternatively, grooves 2a and 2b can be preformed and coated with an elastic polymer, for example a silicone-type polymer, which snugly secures to the teeth when in use.

Grooves 2a and 2b can designed so as to accommodate varying numbers of teeth. For example, only the four canines, upper and lower, may be accommodated by the groove or all twelve of the front teeth (six upper and six lower) may be accommodated with the grooves. In conjunction with rear extension 4a and 4b, all of the teeth, both the anterior and posterior, can be accommodated by the oral appliance. Alternatively, grooves 12a and 12b can be pre-cast, in for example, acrylic or polycarbonate.

The three air passages 3a, 3b and 3c extend horizontally through the single unit body and are preferably located between the grooves 2a and 2b such that air may flow in and out as the user breathes. The air passages 3a-c may be cylindrical, square, or any other shape sufficient to allow the flow of air. Furthermore, the air passages may vary in number, for example additional passages my be provided or fewer passages may be provided. The air passages 3a-c may be formed by drilling or may be molded.

The rear extensions 4a and 4b may be formed from a polymer, for example an acrylic or polycarbonate. The optional filler material of rear extensions 4a and 4b, which snugly secures to the posterior teeth when in use, may be an elastic polymer, for example a silicone-type polymer, or may be L-vax, Ethylene Propylene Diene Monomer (“EPDM”) or silicone which have melting temperatures from about 105° F. to about 195° F. As understood by those skilled in the art, any suitable polymer having a melting point above normal body temperature may be utilized. Thus, rear extensions 4a and 4b may thus be utilized to form teeth holding grooves in the same manners as grooves 2a-b are formed.

Alternatively, rear extensions 4a and 4b may, for example, be formed as a triangular prism, with the end closest to the last back teeth being the thinnest and becoming progressively thicker as it approaches the grooves 2a-b and may be formed from acrylic, polycarbonate, elastic polymers such as silicone, or may be L-vax, Ethylene Propylene Diene Monomer (“EPDM”) or silicone.

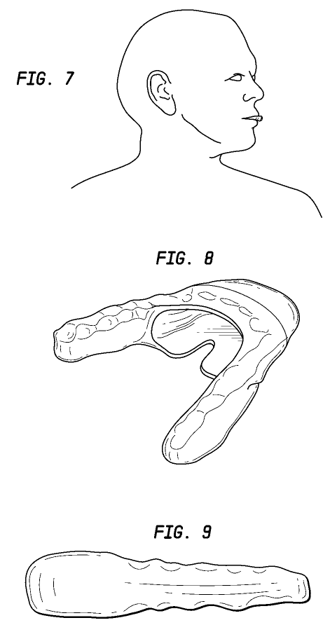

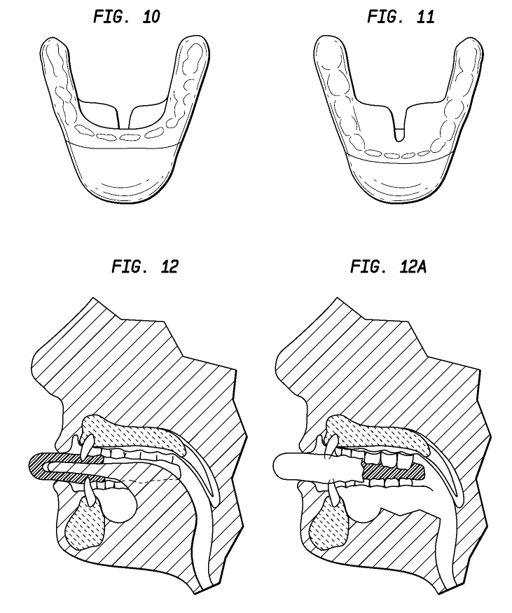

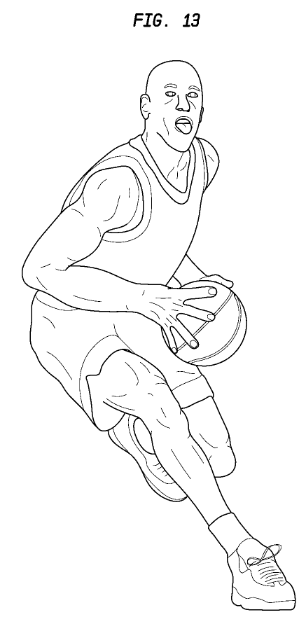

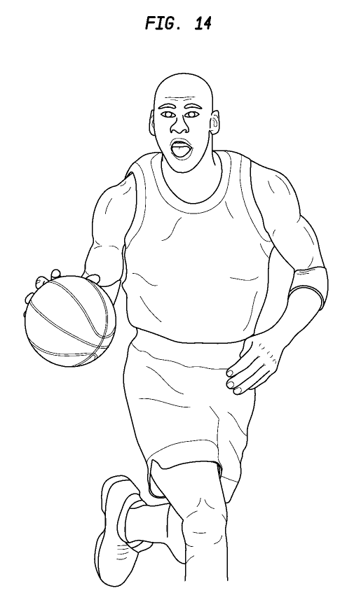

As shown in FIGS. 7-12, an oral appliance in accordance with an embodiment of the present invention comprises a single body unit 11 which has a series of grooves 12a and 12b for the upper and lower teeth, respectively, which serve to hold the lower jaw in an advanced position. Single body unit 11 also has a tongue retaining bulb 13 which serves to hold the tongue in an extended position. Single body unit 11 optionally has rear extensions 14a and 14b which serve to ensure the oral appliance remains aligned within the mouth, to provide posterior support and to provide comfort to the wearer when in use. Furthermore, the groves 12a and 12b and the rear extensions 14a and 14b, or those portions of the rear extensions 14a and 14b, which contact the teeth may be composed of a filler material, an elastic polymer or a polymer as further described below.

The exterior of single body unit 11 is preferably formed from a polymer, for example an acrylic or polycarbonate. The filler material, which forms grooves 12a and 12b, can be a polymer, or polymer made from for example, L-vax, Ethylene Propylene Diene Monomer (“EPDM”) or silicone which have melting temperatures from about 105° F. to about 195° F. As understood by those skilled in the art, any suitable polymer having a melting point above normal body temperature may be utilized. The single body unit 11 may be preformed in one of, for example, three sizes to accommodate different bites such as edge to edge, underbite or overbite. Alternatively, the oral appliance can be provided to users in a one size fits all mode which is accomplished by using an elastic or soft polymer which can deform to fit a variety of bites.

The grooves 12a and 12b can be formed by the user of the oral appliance by first softening single body unit 11, such as by heating in warm or hot water, and then inserting the oral appliance into the mouth and depressing the user's teeth into the softened polymer to form groove marks. The single body unit 11 is then allowed to cool, or optionally immersed in cool water to harden the single body unit 11 for use. Alternatively, grooves 12a and 12b can be preformed and coated with an elastic polymer, for example a silicone-type polymer, which snugly secures to the teeth when in use.

Grooves 12a and 12b can designed so as to accommodate varying numbers of teeth. For example, only the four canines, upper and lower, may be accommodated by the groove or all twelve of the front teeth (six upper and six lower) may be accommodated with the grooves. In conjunction with rear extension 14a and 14b, all of the teeth, both the anterior and posterior, can be accommodated by the oral appliance. Alternatively, grooves 12a and 12b can be pre-cast, in for example, acrylic or polycarbonate.

Tongue retaining bulb 13 may have an outer ring 13a and inner flanges 13b and 13c. Outer ring 13a serves to create a suction-like seal around the tongue when the tongue is engaged in the tongue retaining bulb 13. Inner flanges 13b and 13c, located on either side of the interior surface 13d of tongue retaining bulb 13, serve to guide the tongue into the bulb.

The interior surface 13d of tongue retaining bulb 13 may be coated in an elastic polymer or the tongue retaining bulb 13 may be made of an elastic polymer so as to hold the tongue in place by suction. Polymers useful for the tongue retaining bulb 13 include polymers such as, or polymers formed from, for example, L-vax, EPDM and silicone. Still further, in an alternative embodiment, the tongue retaining bulb 13 may be made out of a hardened plastic, for example acrylic or polycarbonate, so as to additionally serve as a tongue protector, while the interior surface 13d may be made of an elastic polymer, that is, polymers such as, or polymers formed from, for example, L-vax, EPDM and silicone to hold the tongue in place by suction. As understood by those skilled in the art, any suitable polymer which is capable of stretching or deforming so as to hold the tongue via suction may be used.

The rear extensions 14a and 14b may be formed from a polymer, for example an acrylic or polycarbonate. The optional filler material of rear extensions 14a and 14b, which snugly secures to the posterior teeth when in use, may be an elastic polymer, for example a silicone-type polymer, or may be L-vax, Ethylene Propylene Diene Monomer (“EPDM”) or silicone which have melting temperatures from about 105° F. to about 195° F. As understood by those skilled in the art, any suitable polymer having a melting point above normal body temperature may be utilized. Thus, rear extensions 14a and 14b may thus be utilized to form teeth holding grooves in the same manners as grooves 12a-b are formed.

Alternatively, rear extensions 14a and 14b may, for example, be formed as a triangular prism, with the end closest to the last back teeth being the thinnest and becoming progressively thicker as it approaches the grooves 12a-b and may be formed from acrylic, polycarbonate, elastic polymers such as silicone, or may be L-vax, Ethylene Propylene Diene Monomer (“EPDM”) or silicone.

When a user's lower jaw is held in the advanced position and/or the tongue is held in a forward position by the oral appliance, the user's airway is opened allowing the user to breath normally through their nose and/or mouth. Having more open airway passages prevents or reduces the incidence of sleep apnea, increased heart rate and blood pressure, sympathetic nervous response, cardiovascular diseases, diabetes, snoring and attention deficit disorder, all of which have been linked to the reduced ability to get air into the lungs. Furthermore daytime fatigue, low performance, low energy and learning disabilities associated with these aforementioned conditions may be alleviated by use of this oral appliance.

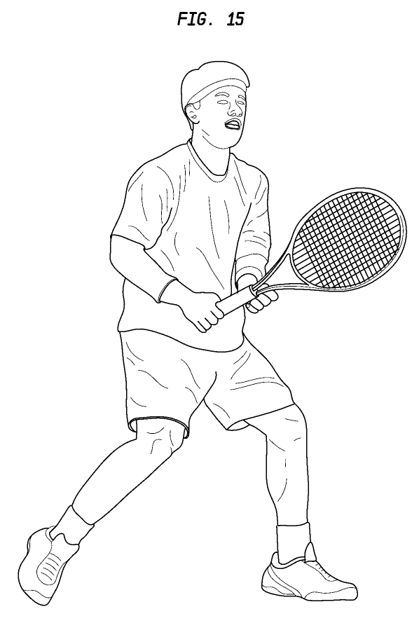

Furthermore, embodiments of the present invention can serve as mouth guards useful in sports and also to improve performance and increase concentration generally. Because these oral appliances increase the air flow to the lungs, they are especially useful in sports. For example, placing the tongue in the forward relaxed position as exemplified in FIGS. 13 and 14 and/or placing the jaw in an advanced position as exemplified in FIG. 15, relaxes the user and enables them to concentrate. This relaxation may be the result of increases in air flow to the lungs, which decreases the sympathetic response, and therefore relaxes the user and enables them to concentrate. The above-mentioned oral appliances may be made in variety of colors, or be multi-colored, for example, with their colors corresponding to the official school or team colors. Thus, embodiments of the present invention can also serve to generally aid the concentration of individuals, prevent or reduce the effects of daytime fatigue, increase performance, increase energy and increase memory and learning.

Still further, because use of the aforementioned oral appliances diminishes arousals during sleep and limits sleep fragmentation, users experience increased REM (Rapid eye movement) and non-REM sleep. This increased non-REM sleep, due to use of the aforementioned oral appliances, will aid the concentration of individuals, prevent or reduce the effects of daytime fatigue, increase performance, increase energy and increase memory and learning.

Lastly, the polymer from which the oral appliances are formed can be impregnated or coated with flavorings, for example vanilla, cherry and the like to make them more acceptable to both adults and children.

### EXAMPLE 1

An embodiment of the present invention is used by a patient exhibiting snoring during sleep. The patient's lower jaw is advanced because the teeth are held within the grooves of the oral appliance and the jaw is thus pulled forward to conform to the shape of the oral appliance. As a result, the patient experiences increased airflow to their lungs and thus their snoring is reduced or eliminated. Additionally, the increased airflow alleviates sleep apnea and reduces the activation of the sympathetic nervous response. Therefore the patient experiences lower blood pressure and heart rate while sleeping and longer periods of REM sleep.

### EXAMPLE 2

An embodiment of the present invention is used by a patient exhibiting snoring during sleep. The patient's lower jaw is advanced because the teeth are held within the grooves of the oral appliance and the jaw is thus pulled forward to conform to the shape of the oral appliance. Furthermore, upon inserting their tongue into the bulb, the patient's tongue is advanced and held forward because the tongue adheres to the inner surface of the bulb by suction. As a result, the patient experiences increased airflow to their lungs and thus their snoring is reduced or eliminated. Additionally, the increased airflow alleviates sleep apnea and reduces the activation of the sympathetic nervous response. Therefore the patient experiences lower blood pressure and heart rate while sleeping and longer periods of REM sleep.

### EXAMPLE 3

An embodiment of the present invention is used by an individual engaging in sports. The patient's lower jaw is advanced because the teeth are held within the grooves of the oral appliance and the jaw is thus pulled forward to conform to the shape of the oral appliance. Furthermore, upon inserting their tongue into the bulb, the patient's tongue is advanced and held forward because the tongue adheres to the inner surface of the bulb by suction. The individual experiences increased airflow to their lungs resulting in greater energy and an increased ability to concentrate. This advanced jaw and/or tongue position also gives the individual greater strength and allows them to enter and remain in a state of peak performance, often commonly referred to in sports as being “in the zone” or by sports psychologists as “peak performance”.

1. An oral appliance comprising:
a first unit which retains the lower jaw and
a second unit which retains the upper jaw,
such that the lower jaw is brought forward from its resting position during sleep.

2. The oral appliance of claim 1 wherein said first and second units have grooves sufficient to retain one or more of the anterior teeth.

3. The oral appliance of claim 2 wherein said grooves are customized to the shape of a user's teeth.

4. The oral appliance of claim 2 wherein said grooves are formed from L-vax, EPDM or silicone polymers.

5. An oral appliance comprising:
An oral appliance comprising
a first unit which retains the lower jaw and
a second unit which retains the upper jaw,
such that the lower jaw is brought forward from its resting position during sleep and further comprising:
a tongue retaining unit
which holds a user's tongue forward from its resting position during sleep.

6. The oral appliance of claim 5 wherein said first and second units have grooves sufficient to retain one or more of the anterior teeth.

7. The oral appliance of claim 6 wherein said grooves are customized to the shape of a user's teeth.

8. The oral appliance of claim 6 wherein said grooves are formed from L-vax, EPDM or silicone polymers.

9. A method of reducing, treating or preventing a sleep disorder comprising:
(a) inserting an oral appliance into the mouth of a patient suffering from a sleep disorder wherein the oral appliance comprises:
a first unit which retains the lower jaw and
a second unit which retains the upper jaw,
such that the lower jaw is brought forward from its resting position during sleep, and
(b) maintaining the oral appliance within the patient's mouth during at least a portion of the patient's sleep period.

10. The method of claim 9 wherein said sleep disorder is sleep apnea or snoring.

11. The method of claim 9 where said sleep disorder is a causative factor for cardiovascular disease, diabetes, attention deficit disorder, daytime fatigue, low performance, low energy and learning disorders.

12. A method of improving performance and concentration in an individual comprising:
(a) inserting an oral appliance into the mouth of an individual wherein the oral appliance comprises:
a first unit which retains the lower jaw and
a second unit which retains the upper jaw,
such that the lower jaw is brought forward from its normal position, and
(b) maintaining the oral appliance within the individual's mouth during at least a portion of the patient's daytime activities.

13. The method of claim 12 wherein improved performance and concentration results in prevention or reduction of the effects of daytime fatigue, increases performance, increases energy and increases memory and learning.

14. The method of claim 12 wherein improved performance and concentration results in the achievement of a state of peak performance during sports.

15. A method of reducing, treating or preventing a sleep disorder comprising:
(a) inserting an oral appliance into the mouth of a patient suffering from a sleep disorder wherein the oral appliance comprises:
a first unit which retains the lower jaw and
a second unit which retains the upper jaw,
such that the lower jaw is brought forward from its resting position during sleep, and
wherein the oral appliance further comprises:
a tongue retaining unit
which holds a user's tongue forward from its resting position during sleep, and
(b) maintaining the oral appliance within the patient's mouth during at least a portion of the patient's sleep period.

16. The method of claim 15 wherein said sleep disorder is sleep apnea or snoring.

17. The method of claim 16 where said sleep disorder is a causative factor for cardiovascular disease, diabetes, attention deficit disorder, daytime fatigue, low performance, low energy and learning disorders.

18. A method of improving performance and concentration in an individual comprising:
(a) inserting an oral appliance into the mouth of an individual wherein the oral appliance comprises:
a first unit which retains the lower jaw and
a second unit which retains the upper jaw,
such that the lower jaw is brought forward from its normal position, and
wherein the oral appliance further comprises:
a tongue retaining unit
which holds a user's tongue forward from its normal position, and
(b) maintaining the oral appliance within the individual's mouth during at least a portion of the patient's daytime activities.

19. The method of claim 18 wherein improved performance and concentration results in prevention or reduction of the effects of daytime fatigue, increases performance, increases energy and increases memory and learning.

20. The method of claim 18 wherein improved performance and concentration results in the achievement of a state of peak performance during sports.
